(19) United States
(12) Patent Application Publication
(10) Pub. No.: US 2013/0074062 A1
(43) Pub. Date: Mar. 21, 2013

(54) METHOD FOR OPERATING A HOUSEHOLD APPLIANCE AND SYSTEM INCLUDING SUCH A HOUSEHOLD APPLIANCE

(71) Applicants: Stephan Arnold, Gifhorn (DE); Rudolf Herden, Herzebrock-Clarholz (DE); Ernst Hokamp, Guetersloh (DE); Annette Meyer, Brake (DE); Achim Schoening, Bielefeld (DE); Christian Schrutek, Karlsruhe (DE); Ralf Westerheide, Hilter (DE)

(72) Inventors: Stephan Arnold, Gifhorn (DE); Rudolf Herden, Herzebrock-Clarholz (DE); Ernst Hokamp, Guetersloh (DE); Annette Meyer, Brake (DE); Achim Schoening, Bielefeld (DE); Christian Schrutek, Karlsruhe (DE); Ralf Westerheide, Hilter (DE)

(73) Assignee: MIELE & CIE. KG, Guetersloh (DE)

(21) Appl. No.: 13/617,417

(22) Filed: Sep. 14, 2012

(30) Foreign Application Priority Data
Sep. 20, 2011 (EP) 11 401 596.9

(51) Int. Cl. G06F 9/44

(52) U.S. Cl. 717/171

(57) ABSTRACT

A method for operating a household appliance includes detecting an identifier of the household appliance with a mobile device having a data collector, where the household appliance has a memory containing a control program and at least one appliance program executable by the control program and a processing unit configured to execute the control program. A database that is accessible on the internet is accessed using the identifier and the mobile device. At least one appliance program is selected and transmitted to the mobile device. The at least one appliance program is transferred to the memory of the household appliance.

### CROSS REFERENCE TO RELATED APPLICATIONS

This application claims priority to European Patent No. EP 11 401 596.9, filed Sep. 20, 2011, which is hereby incorporated by reference herein in its entirety.

### FIELD

The present invention relates to a method for operating a household appliance, such as an automatic washing machine, a dryer, a dishwasher, a cooking appliance, or a beverage preparing device, and to a system including such a household appliance.

### BACKGROUND

Household appliances are per se known. Every household appliance has at least one appliance program, and usually a plurality of appliance programs. To date, such appliance programs have frequently been implemented in hardware, namely in the form of a so-called “programmer/timer”. It is equally possible to implement appliance programs in software, and appliance programs implemented in software offer additional flexibility, for example, when it comes to their modification or when one wishes to provide different or additional appliance programs in the household appliance.

Such software-implemented appliance programs can be stored in a memory of the appliance during the manufacture thereof and are available therein for direct or indirect execution by a processing unit in the form of or similar to a microprocessor. In order to execute appliance programs, the memory of the appliance typically contains a control program, which is executed by the processing unit and which, during operation, executes an appliance program selected by a user.

Starting from a situation where a household appliance is delivered with one or more software-implemented appliance programs, the user often develops the desire to adapt the functionality of the appliance to his or her particular needs and, in this connection, to have available in the respective appliance a number and type of appliance programs that are geared to the particular application situation. To this end, a service technician may transfer new appliance programs to the appliance, or delete or modify existing appliance programs, using suitable hardware, such as a programming device or the like. Frequently, however, a user does not want to choose a method that requires the involvement of a service technician, or he or she wants a desired change to be available as soon as possible without depending on the schedule and working hours of such personnel.

WO 2011/103680 A1 describes downloading software through the Internet using a mobile device, and subsequently transferring the software from the mobile device into the household appliance to run a general program update.

Document WO 2006 /083416 A2 describes a method in which an entertainment device can be remotely controlled by a mobile device. To this end, an RFID code is read to identify the entertainment device, so that the mobile device can cause commands for the identified entertainment device to be suitably translated and fed to the entertainment device.

German document DE 199 08 164 A1 generally describes a method for configuring a household appliance where program data can be loaded into the controller of the appliance via what is known as a remote data connection.

### SUMMARY

In an embodiment, the present invention provides a method for operating a household appliance including detecting an identifier of the household appliance with a mobile device having a data collector, where the household appliance has a memory containing a control program and at least one appliance program executable by the control program and a processing unit configured to execute the control program. A database that is accessible on the internet is accessed using the identifier and the mobile device. At least one appliance program is selected and transmitted to the mobile device. The at least one appliance program is transferred to the memory of the household appliance.

### BRIEF DESCRIPTION OF THE DRAWINGS

Exemplary embodiments of the present invention will be described in more detail below with reference to the drawings. Corresponding objects or elements are identified by the same reference numerals in all figures. It is understood that neither the described nor any other exemplary embodiment should be construed as limiting the scope of the present invention. Rather, within the framework of the present disclosure, numerous revisions and modifications are possible, which, for example, by combining or altering individual features or method steps described in connection with the general description and the, or each, particular embodiment, as well as the claims, and contained in the drawings, may be inferred by one skilled in the art with regard to achieving the objective, and lead, through combinable features, to a new subject matter or to new method steps or sequences of method steps. In the drawing,

FIG. 1 shows a system including a household appliance and a mobile device for accessing a database available on the Internet;

FIG. 2 illustrates a controller of the household appliance with further details;

FIG. 3 shows the mobile device with further details;

FIG. 4 illustrates the operation of the method proposed herein;

FIGS. 5a, 5b show alternative ways of communicatively connecting the automatic washing machine and the mobile device;

FIG. 6 shows is a flow diagram of the method proposed herein.

### DETAILED DESCRIPTION

An aspect of the present invention is to provide a method for operating a household appliance and a system including such a household appliance which will provide a particularly easy and flexible way to update or supplement appliance programs in the memory of a household appliance.

In an embodiment, the present invention provides a method for operating a household appliance, the appliance including a memory containing a control program and at least one appliance program executable by the control program and further including a processing unit for executing the control program, provision is made that an appliance identifier provided on the household appliance is detected by a mobile device including at least a camera or similar data collection means, and that a database accessible on the Internet, or generally by way of data communication, is accessed using the identifier and the mobile device, and that one or more appliance programs are selected in the database and transmitted to the mobile device, and that the or each appliance program transmitted to the mobile device is transferred into the memory of the household appliance.

In an embodiment, the present invention allows a mobile device, such as a mobile telephone, a so-called handheld computer, a laptop, etc., to function as an interface between the household appliance and a database of appliance programs available on the Internet. Such mobile devices exist in many households, so that without having to make additional purchases, a user of a household appliance is given the possibility to access appliance programs available on the Internet in order to select them for transmission to his or her household appliance. Access to the database via the mobile device is performed specifically for the respective household appliances. To this end, an identifier of the household appliance is detected using the mobile device. The detection of such an identifier may be accomplished by a camera, which is usually included in mobile radio devices as an example of a class of mobile devices. Another suitable way to detect an identifier of the household appliance is, for example, by using a so-called RFID system in which the automatic washing machine has a transponder and the mobile device also functions at least as an RFID reading device. It is also possible to use laser scanners for this task. Without loss of generality, the present description is continued assuming that an identifier is detected by a camera of the mobile device. In this connection, other data collection means are always implied.

In order to identify the household appliance, the camera captures an image of the automatic washing machine, or of a significant part of the household appliance, such as the control panel, which has a characteristic array of controls and indicators, or of a portion of the household appliance that has a type identifier or the like typically provided on the outside thereof, and an identifier identifying the household appliance is derived by interpreting the image data so acquired. Depending on this identifier; i.e., only if this identifier is present, a database accessible on the Internet is then accessed using the mobile device. In the database, one or more appliance programs are selected and transmitted to the mobile device. Subsequently, the appliance program or all appliance programs that has/have been downloaded is/are transferred into the memory of the household appliance. There, the new or modified appliance program is then available for execution by the control program and, in connection with the transfer of an appliance program into the memory, or when the control program searches for appliance programs in the memory, a new appliance program is notified to the control program, so that this new appliance program can be selected using a control device on the household appliance and subsequently executed on or in the household appliance.

Advantageously, by using a mobile device such as, for example, a mobile telephone, as an interface between the household appliance and a database of appliance programs available on the Internet, the user is given a heretofore unknown flexibility in situations where he or she wishes to modify or supplement the appliance programs available on his or her household appliance. In this connection, the user is even independent of the location of the household appliance and, once an identifier identifying the household appliance is detected, he or she can access the database and select one or more appliance programs from a place that is convenient to him or her, where he or she can unhurriedly compare the appliance programs available in the database and finally select one or more appliance programs for transmission to the respective mobile device. It is only for the transfer of the or each appliance program or programs transmitted to the mobile device that the mobile device needs to be brought near the household appliance again to allow a communicative connection required for the transfer to be established between the mobile device and the automatic washing machine.

One embodiment of the method is based on that the identifier of the household appliance is in the form of a bar code or in the form of a so-called data matrix or the like located in a position on the household appliance that is accessible to the mobile device, such as, for example, a position on one of the outer surfaces thereof. Such an identifier can then be detected using the mobile device, namely by the camera thereof. By analyzing the image data so acquired, the identifier can be interpreted and converted into a datum suitable for being passed on and, in particular, for logging on to the database available on the Internet. The use of a bar code as the basis for the identifier has the advantage that household appliances are usually provided with such an identifier or a similar one already during the manufacturing process or during final inspection, or at least when they are prepared to be sold, so that this embodiment of the method does not require any special measures to be taken with regard to the household appliance. Since mobile devices such as, for example, mobile telephones usually have a camera and means for processing the image data captured by the camera, there is no need to change the configuration of such mobile devices. Accordingly, it is sufficient to modify an operating software of the mobile device such that the captured image data can be processed to enable the respective identifier to be interpreted and converted into a datum suitable for being passed on.

If the identifier, or a datum generated based on the identifier (both terms will be used synonymously hereinafter), is permanently stored in the mobile device and allows repeated access to the database, the user is freed from the need to capture the identifier again each time he or she accesses the database available on the Internet. On this basis, the user of the household appliance can access the database available on the Internet virtually regularly, and even when traveling or during times of leisure, to check if there are any new or modified appliance programs available for his or her household appliance.

In order for an appliance program transmitted to the mobile device to be transferred into the memory of the household appliance, a temporary wireless or wired communicative connection is established between the mobile device and the household appliance. This enables the mobile device to access the household appliance and its memory. The control program in the automatic washing machine detects the connection of the mobile device and performs a check, as a result of which communication with the mobile device is either allowed or disallowed. If communication with the mobile device is to be allowed, the data of at least one appliance program starts to be transferred to the household appliance and the controller thereof. The data of the respective appliance program is stored in the memory of the controller under the control of the control software executed therein. In the process, the control program monitors the use of the memory areas created in the memory, so that a new appliance program will only be transferred into an unoccupied memory area, or at least into a memory area which is occupied by an appliance program that is no longer used. The control program recognizes identical or similar appliance programs, for example, by an identifier and, possibly, and additional revision number or the like, which allows for an embodiment where a new appliance program replaces a previous older appliance program. It may also be provided that an appliance program for which an older counterpart already exists in the memory of the household appliance is first transferred into an unoccupied or otherwise available memory area, and that the older appliance program to be replaced is not deleted, or the respective memory area is not marked as available again, until the transfer of the new appliance program is successfully completed. The transfer of the data of an appliance program can be monitored using generally known methods. For example, a protocol which detects data transmission errors and which, when such errors occur, causes the transmission, or possibly part of the transmission, to be repeated may be used already in the communicative connection between the mobile device and the automatic washing machine. Additionally or alternatively, it may be provided that the appliance program has a checksum, and that after the household program is transferred, a comparison value is calculated over the transferred appliance program by a suitable algorithm and compared to the checksum. A transferred appliance program is only marked as properly transferred and usable when the checksum and the comparison value match each other or at least sufficiently match each other.

In one embodiment, in order to provide the communicative connection between the mobile device and the automatic washing machine, the automatic washing machine and the mobile device may be connected by a data cable. The use of a data cable and the wired communication thereby made possible have the advantage of a relatively secure data transmission that is likely to be unaffected by electromagnetic fields.

In an alternative embodiment of the method, in order to provide the communicative connection between the mobile device and the automatic washing machine, a transceiver for wireless data transmission is connected to the automatic washing machine, and the automatic washing machine is wirelessly communicatively connected to the mobile device via the transceiver. Such an embodiment has the advantage that the mobile device does not need to have a port or connector or any other contact means for a data cable or the like, and that the communication with the transceiver may be accomplished using a corresponding transceiver of the mobile device, which the mobile device, being specifically a mobile radio device, usually has anyway. In addition, the use of a transceiver has the advantage that it may be connected to the household appliance over a longer period of time or be integrated into the household appliance as a permanent part thereof. Even if the transceiver is not integrated into the household appliance and has to be attached to the household appliance by the user, it is very well possible to attach such a transceiver to a side of the household appliance that is not visible, such as the rear side thereof, so that it does not impair the normal use of the appliance, yet allows the mobile device to access the appliance at any time.

Overall, the present invention also relates to a system including a household appliance and a mobile device, where the automatic washing machine and the mobile device include means for implementing the method as described here and below. At both the side of the household appliance and the side of the mobile device, the means for implementing the method to be mentioned are, first of all, a processing unit in the form of or similar to a microprocessor and a control program or computer program which is executable by this processing unit and implements the various steps of the method and which, when executed, performs the method or one of its embodiments.

Thus, embodiments of the present invention also relate to such a system which includes a data cable connectable to the household appliance and to the mobile device and/or a transceiver connectable to the household appliance in order to communicatively connect the automatic washing machine and the mobile device. In this connection, the mobile device functionally acts as a transmission means or medium between the automatic washing machine and the database available on the Internet. Mobile devices commonly used today, such as mobile telephones, notebook computers, PDAs, etc., usually already have a function for accessing the Internet, so that this function can also be used for the method described here and below, and thus, the mobile device is suitable to form part of the system. However, a communicative connection between the automatic washing machine and the mobile device is not possible straight away, so that, in a particular embodiment, either a data cable or a transceiver connectable to the household appliance is included in the system to make such a communicative connection possible. Suitable mobile devices include, in particular, so-called smartphones which include a camera and a special application, known as “app”, for providing the communicative connection with the household appliance and for organizing and carrying out the data transmission.

In an embodiment, the present invention also provides a household appliance and a mobile device which operate in accordance with the method as described here and below and, to this end, include means for implementing the method. One suitable mobile device is, in particular, a so-called smartphone onto which so-called application programs (apps) can be loaded specifically for the above-mentioned data transfer, and which are then made available and presented to the user for user control. The present invention is preferably implemented in software. Thus, the present invention is, firstly, also a computer program including program code instructions executable by a computer, and secondly, a memory medium containing such a computer program, and finally also an automatic washing machine or a controller of a household appliance and a mobile device into whose memory such a computer program is loaded or loadable as a means for implementing the method and embodiments thereof.

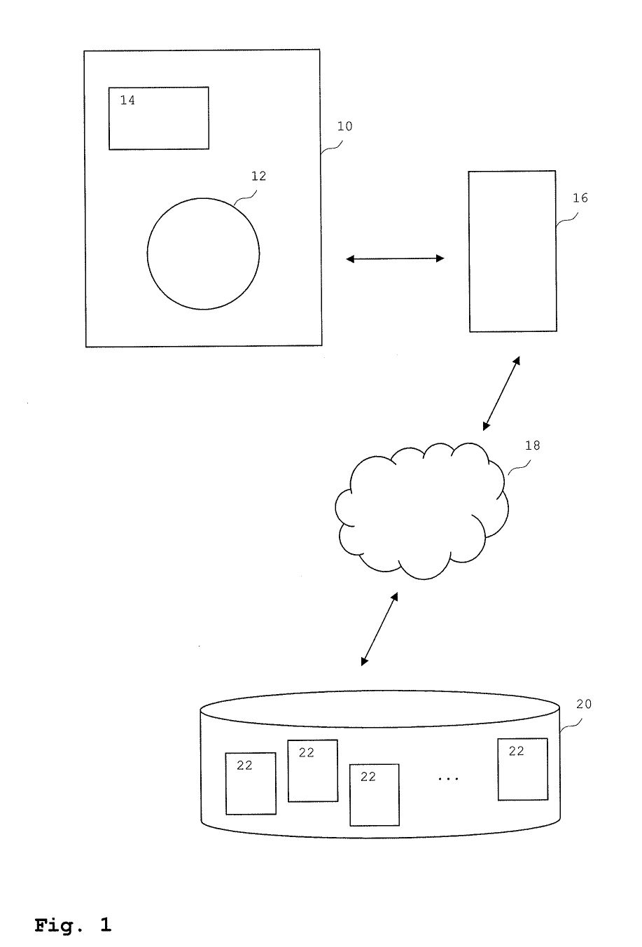

FIG. 1 shows, in simplified schematic form, a household appliance 10 in the form of an automatic washing machine which, in addition to known components and assemblies, is known to include a drum 12, a drum motor, a heater, a water inlet, etc. and, in addition, a controller 14. In addition to household appliance 10, there are also shown a mobile device 16 and the Internet 18, represented as a cloud. A database 20 containing appliance programs 22 or other data for a household appliance 10 is accessible on or via the Internet 18. The double-headed arrows between automatic washing machine 10 and mobile device 16 on the one hand, and between mobile device 16 and database 20 on the other hand, illustrate a communicative connection. The communicative connection between the aforementioned units may be accomplished wirelessly or by wire. Mobile device 16 may be, for example, a mobile telephone, a portable computer in the form of a laptop, notebook, tablet computer, etc. or a portable computer in the form of a so-called PDA (personal digital assistant).

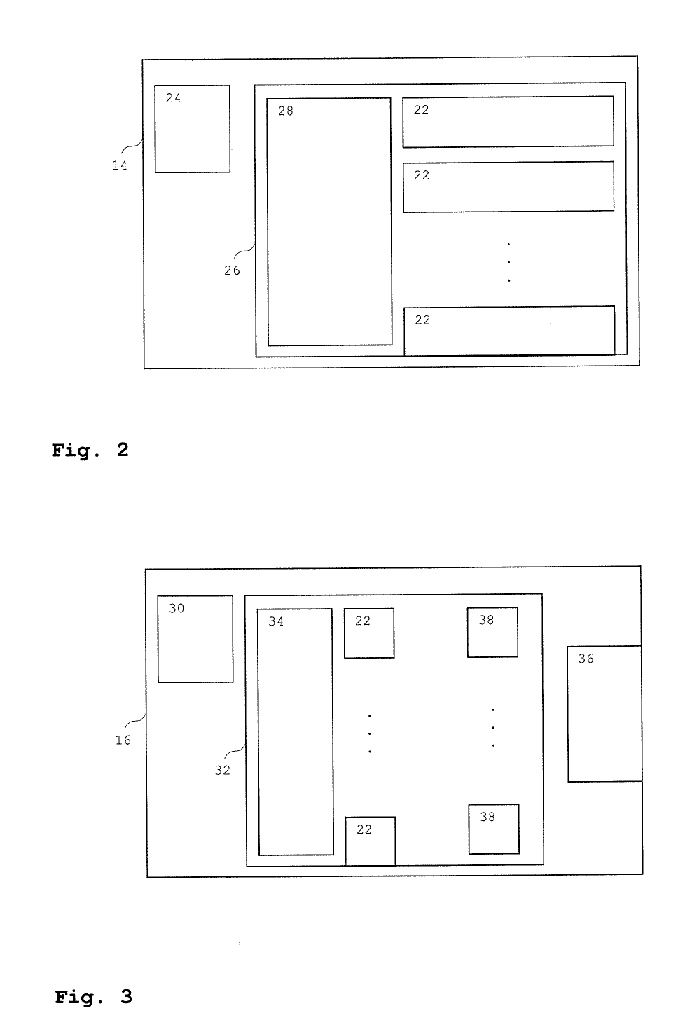

FIG. 2 is a block diagram showing controller 14 of household appliance 10 with further details. Accordingly, and as is generally known, the controller includes a processing unit 24 in the form of or similar to a microprocessor, as well as a memory 26. Memory 26 has loaded therein a control program 28 and at least one appliance program 22 executable by control program 28. During the operation of household appliance 10, control program 28 is executed by processing unit 24 in a usual manner. It is expedient for the control program to include only general program parts and to be stored in a read-only memory area. The memory area of the individual wash programs 22 takes the form of a programmable or rewritable random access memory, such as flash memory. The memory area for the general control program 28 may also be stored in the rewritable area which, however, is not changed or overwritten when updating individual wash programs 22.

FIG. 3 is a block diagram mobile device 16 with further details. Accordingly, mobile device 16 also has a processing unit 30 and a memory 32, such as described above for controller 14. Memory 32 has loaded therein an operating program 34. Moreover, memory 32 provides space for one or more appliance programs 22 loaded from database 20 (FIG. 1). Further, mobile device 16 includes a camera 36 as an example of a device for collecting data (data collection means). Image data 38 captured by camera 36 may also be loaded into memory 32. Image data 38 is processable and/or interpretable by operating program 34, for example, using algorithms of what is known as image processing to obtain, from the image data, information suitable for being passed on.

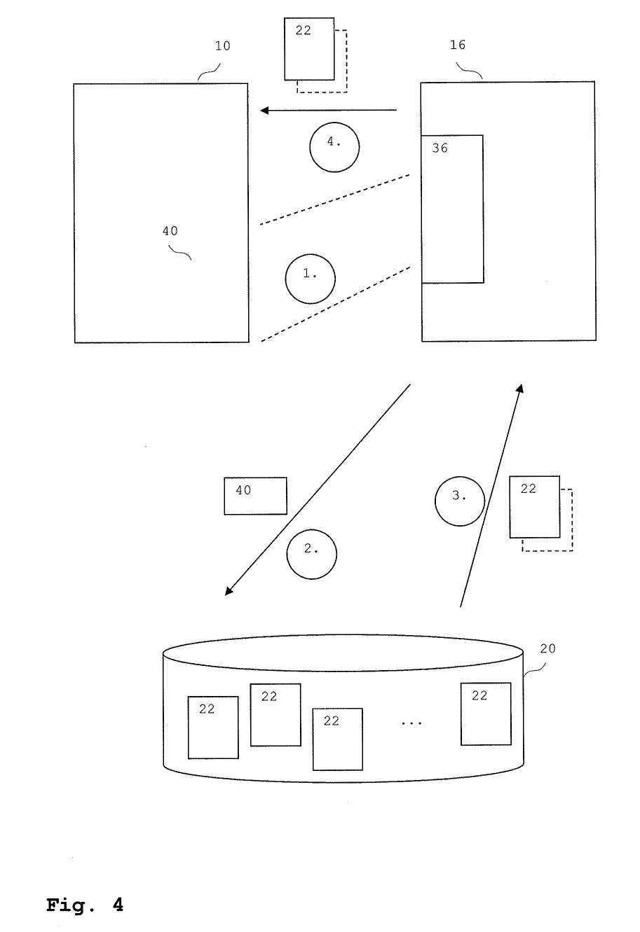

FIG. 4 illustrates the operation of the method in simplified schematic form. Accordingly, in a first step (1.), an identifier 40 of household appliance 10, such as a bar code on the outside of appliance 10 or in the user manual, is detected by camera 36 of mobile device 16. The image data 38 (FIG. 3) resulting from the detected identifier 40 is interpreted by mobile device 16 using suitable image processing routines. A datum which is also referred to as an identifier and which is based on the identifier 40 detected by camera 38, such as, for example, the numerical value of bar code 40, is used to access (2.) the database 20 available on the Internet 18. There, one or more appliance programs 22 associated with identifier 40 are selected and transmitted (3.) to mobile device 16, and from there finally transferred into memory 26 of household appliance 10 (step 4.). In a suitable embodiment, the programs 22 that are suitable for the particular identifier are merely offered for download; the user can then select the programs 22 that are actually to be transmitted.

Along with identifier 40 or a datum based thereon, additional data for accessing database 20 may be transmitted thereto. Identifier 40 serves to allow appliance programs 22 suitable for a particular household appliance 10 to be made available automatically. The additional data may be provided for authentication of mobile device 16, so that only authorized accesses to database 20 will enable the selection of appliance programs 22.

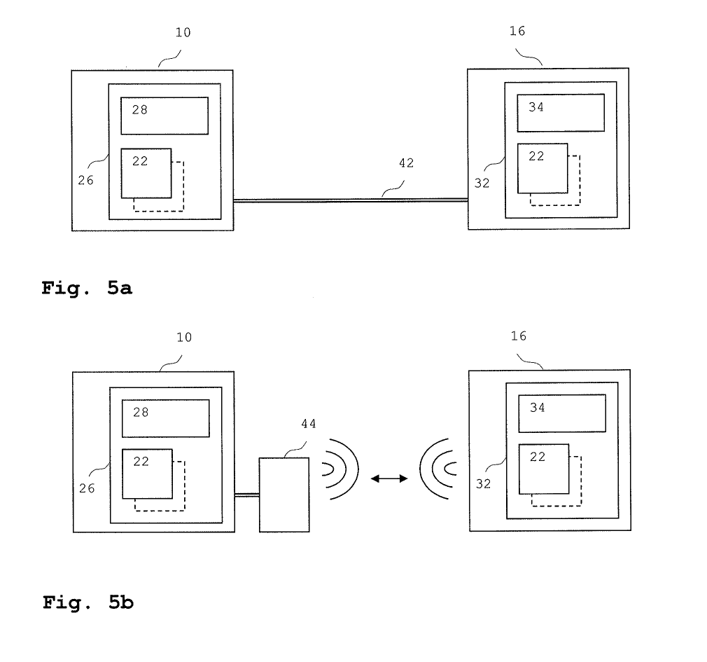

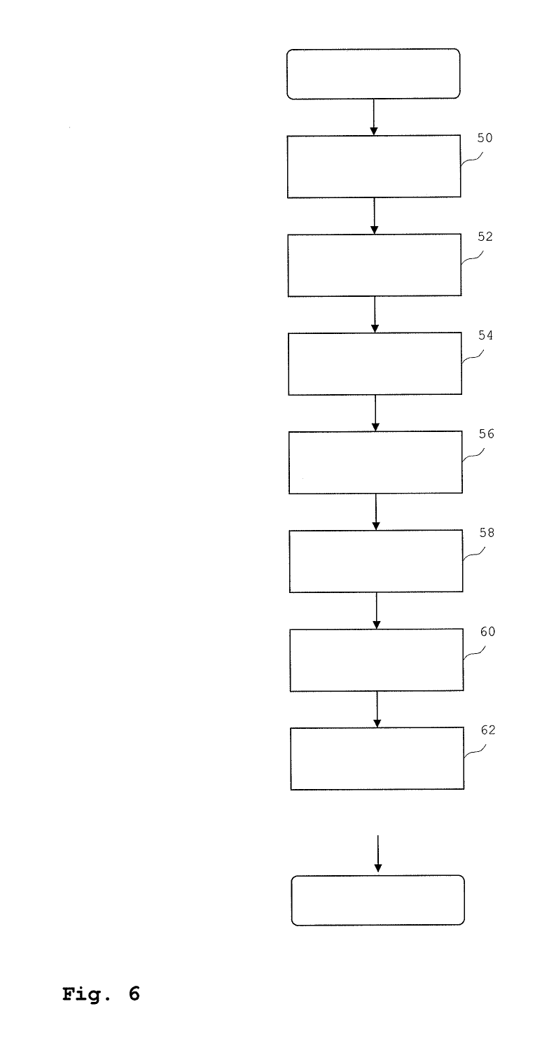

FIGS. 5a and 5b illustrate two aspects of the step in which appliance programs 22 loaded from database 20 are transferred from mobile device 16 into memory 26 of household appliance 10. Accordingly, a communicative connection exists, at least temporarily, between mobile device 16 and household appliance 10, either via a data cable 42 as illustrated in FIG. 5a, or, as in the embodiment shown in FIG. 5b, a transceiver 44 for wireless data transmission is connected to automatic washing machine 10, so that automatic washing machine 10 is wirelessly communicatively connected to mobile device 16 via transceiver 44. Mobile device 16, being a mobile telephone, laptop computer with WLAN adapter, etc., has a transceiver of its own (not shown), so that the communicative connection can be established between the two units. Regardless of whether the communicative connection is established by wire or wirelessly, any communications protocol now known, or known in the future, can be used for the data transmission made possible by the communicative connection. Examples of such communications protocols include those for serial transmission according to the standards known as RS-232, FireWire, Bluetooth or Ethernet. The actual communications processes, and thus the initiated data transmission, are handled by the computer programs involved at both sides; i.e., control program 28 at the side of household appliance 10 and operating program 34 at the side of the mobile device. To this end, operating program 34 sends, for example, a request to control program 28, which normally responds thereto by allowing data transmission. The transmitted data is read into memory 26 of controller 14 (FIG. 2) of household appliance 10. Once a check or the like shows that the data constitutes a completely and correctly transmitted appliance program 22, the data may be marked as an appliance program 22 or be transferred into a specific memory area for appliance programs 22. Then, the new appliance program 22 is available for execution by control program 28.

Finally, FIG. 6 once again illustrates several salient aspects of the method by way of a simplified schematic flow diagram. Accordingly, initially (first functional block 50), an identifier 40 of household appliance 10 is captured using mobile device 16 and means included therein, such as, for example, its camera 36. If necessary, this identifier 40 is then interpreted (second functional block 52), for example, by converting the image data 38 captured by camera 36 using image processing algorithms and by extracting the information contained in image data 38. The result of such processing is a datum which is based on identifier 40, such as, for example, the numerical value of a bar code used as identifier 40. The datum based on identifier 40 is also referred to as an identifier and is transmitted, possibly along with other data (e.g., authentication data), to the database 20 available on the Internet 18 (functional block 54). Transmission to database 20 is always meant to imply that a communicative connection is established with a computer which is also referred to as server in the terminology of the field and on which database 20 is maintained, or which can otherwise access database 20. The transmitted identifier allows appliance programs 22 which are suitable for a particular household appliance 10 to be preselected at the side of database 20. In a next step (fourth functional block 56), while database 20 is accessed using mobile device 16, at least one appliance program 22 is selected from the pre-selection made available based on the identifier. The or each appliance program 22 is then transmitted to mobile device 16 and at least temporarily stored in its memory 32 (fifth functional block 58). Once a communicative connection exists or is established between mobile device 16 and household appliance 10, the or each appliance program 22 can be transferred into memory 26 of household appliance 10. This is done by transmitting the data included in appliance program 22 (sixth functional block 60). After the data of appliance program 22 is loaded into memory 26, a check is performed (seventh functional block 62), and if the check is successful, the new appliance program 22 is available for execution by control program 28.

Thus, various salient aspects of the description given herein can be briefly summarized as follows, using the example of an automatic washing machine: Disclosed is a method for operating a household appliance, here an automatic washing machine 10, said automatic washing machine 10 or controller 14 including a memory 26 containing a control program 28 and at least one appliance program 22 executable by the control program 28 and further including a processing unit 24 for executing control program 28, in which method an identifier 40 of automatic washing machine 10 is detected, a database 20 accessible on the Internet 18 is accessed using identifier 40 and mobile device 16, and one or more washing machine programs 22 are selected and transmitted to mobile telephone device 16, and in which the or each washing machine program 22 transmitted to mobile device 16 is transferred into memory 26 of the automatic washing machine. The detection of identifier 40 may be accomplished using, for example, a camera 36, which is usually included in a mobile device 16 in the form of a mobile telephone. However, it is also possible to use any other data collection means such as, for example, a device for reading RFID data, a laser scanner, or the like. In any case, the particular automatic washing machine is uniquely identified by detecting identifier 40, and identifier 40 is used as a basis for selecting washing machine programs 22 suitable for automatic washing machine 10 in the database 20 accessible on the Internet 18. When intended for use in a dryer, appliance programs 22 include corresponding dryer programs or parameter options. In the case of cooking appliances, these programs 22 include corresponding cooking programs or menu cooking programs, while for fully automatic beverage makers or fully automatic coffee makers they include corresponding preparation programs.

While the invention has been particularly shown and described with reference to preferred embodiments thereof, it will be understood by those skilled in the art that various changes in form and details may be made therein without departing from the spirit and scope of the invention.

### LIST OF REFERENCE NUMERALS

10 automatic washing machine, household appliance

12 drum

14 controller

16 mobile device

18 Internet

20 database

22 washing machine programs, appliance programs

24 processing unit

26 memory

28 control program

30 processing unit (of the mobile device)

32 memory (of the mobile device)

34 operating program (of the mobile device)

36 camera

38 image data

40 identifier

42 data cable

44 transceiver

50 first functional block

52 second functional block

54 third functional block

56 fourth functional block

58 fifth functional block

60 sixth functional block

62 seventh functional block

1. A method for operating a household appliance that includes a memory containing a control program and at least one appliance program executable by the control program, and a processing unit configured to execute the control program, the method comprising:
detecting an identifier of the household appliance with a mobile device including a data collector;
accessing a database that is accessible on the internet using the identifier and the mobile device;
selecting at least one appliance program and transmitting the at least one appliance program to the mobile device;
transferring the at least one appliance program to the memory of the household appliance.

2. The method recited in claim 1, wherein the household appliance is an automatic washing machine, a dryer, a dishwasher, a cooking appliance or a beverage preparing device.

3. The method recited in claim 1, wherein the data collector is a camera.

4. The method recited in claim 1, wherein the identifier of the household appliance is a bar code or a smart code and is disposed in a position on the household appliance that is accessible to the mobile device; and
wherein the method include detecting and interpreting the identifier using the mobile device.

5. The method recited in claim 4, further comprising permanently storing the identifier in the mobile device so as to allow repeated access to the database.

6. The method recited in claim 1, further comprising establishing a temporary wireless or wired communicative connection between the mobile device and the household appliance so as to transfer the appliance program transmitted to the mobile device into the memory of the household appliance.

7. The method recited in claim 6, wherein the establishing a communicative connection between the mobile device and the household appliance includes connecting the household appliance and mobile device by a data cable.

8. The method recited in claim 6, wherein the establishing a communicative connection between the mobile device and the household appliance includes connecting a transceiver for wireless data transmission to the household appliance; and
wirelessly communicatively connecting the household appliance to the mobile device with the transceiver.

9. A system comprising:
a household appliance including:
a memory containing a control program and at least one appliance program executable by the control program, and
a processing unit configured to execute the control program, and
a mobile device including a processing unit configured to execute the steps of:
detect an identifier of the household appliance using a data collector of the mobile device,
access a database that is accessible on the Internet and select and receive at least one appliance program, and
transmit the at least one appliance program into the memory of the household appliance.

10. The system recited in claim 9, further comprising a data cable that is connectable to the household appliance and the mobile device so as to communicatively connect the mobile device and the household appliance.

11. The system recited in claim 9, further comprising a transceiver that is connectable to the household appliance and the mobile device so as to communicatively connect the mobile device and the household appliance.

12. A mobile device comprising a tangible non-transient computer-readable medium having computer-executable instructions stored thereon to be executed by a processing unit of the mobile device, the computer-executable instructions comprising:
instructions for:
detecting an identifier of a household appliance using a data collector of the mobile device,
accessing a database that is accessible on the Internet and selecting and receiving at least one appliance program, and
transmitting the at least one appliance program into a memory of the household appliance.
